(19) United States
(12) Patent Application Publication
(10) Pub. No.: US 2026/0326810 A1
(43) Pub. Date: Oct. 22, 2026

(54) OPERATION CONTROL DEVICE AND INPUT DEVICE

(71) Applicants: KABUSHIKI KAISHA TOKAI RIKA DENKI SEISAKUSHO, Aichi (JP); TOYOTA JIDOSHA KABUSHIKI KAISHA, Aichi-ken (JP)

(72) Inventors: Takeshi OHNISHI, Aichi (JP); Takuma FUKUDA, Aichi (JP); Kana KATASHIMA, Aichi (JP); Yasutaka MATSUDA, Aichi (JP); Masahiro INOUE, Aichi (JP); Junichi FUKUI, Aichi (JP); Yoshiyuki MURAMATSU, Aichi-gun (JP); Shumpei SUGIMURA, Kasugai-shi (JP); Yoshimasa MIURA, Toyota-shi (JP); Satoshi YAMAMICHI, Nagoya-shi (JP)

(73) Assignees: KABUSHIKI KAISHA TOKAI RIKA DENKI SEISAKUSHO, Aichi (JP); TOYOTA JIDOSHA KABUSHIKI KAISHA, Aichi-ken (JP)

(21) Appl. No.: 19/653,583

(22) Filed: Apr. 21, 2026

(30) Foreign Application Priority Data
Apr. 22, 2025 (JP) 2025-070167

(51) Int. Cl. B62D 1/04; B62D 1/06; G06F 3/044

(52) U.S. Cl. CPC B62D 1/043; B62D 1/06; G06F 3/044; G06F 2203/04108

(57) ABSTRACT

An operation control device includes a shaft and a grip. The shaft is rotatable about an axis to be associated with a first operation. The grip is gripped by a user's hand to turn about the axis. An input device is disposed between the shaft and the grip when viewed from a first direction along the axis. First and second areas are associated with second and third operations, respectively. The second area is disposed between the grip and the first area when viewed from the first direction. First and second electrodes are arranged to detect change in electrostatic capacitance caused by approach or contact of a user's finger with respect to the first and second areas, respectively. A length of the first electrode in a second direction along a turning radius of the grip is longer than a length of the second electrode in the second direction.

### CROSS-REFERENCE TO RELATED APPLICATION

The present application is based on Japanese Patent Application No. 2025-070167 filed on Apr. 22, 2025, the entire contents of which are incorporated herein by reference.

### BACKGROUND

The presently disclosed subject matter relates to an operation control device equipped with an input device adapted to control an operation of a controlled device. The presently disclosed subject matter also relates to an input device adapted to be equipped with the operation control device.

Japanese Patent Publication No. 2007-317393A discloses a steering device as an exemplary operation control device that is adapted to be installed in a vehicle as an exemplary mobility. The steering device includes a steering member configured to be rotated about a rotation axis to change a traveling direction of the vehicle. An input device is disposed on the steering member. The input device includes multiple operation accepting areas. The operation accepting areas are associated with different operations of at least one controlled device. Each of the operation accepting areas is adapted to detect change in electrostatic capacitance caused by approach or contact of a driver's finger. When change in the electrostatic capacitance exceeding a threshold value is detected in a specific operation accepting area, an operation of the controlled device associated with the operation accepting area is executed.

### SUMMARY

There is a need for improving the convenience of an operation control device equipped with an input device adapted to control multiple operations of a controlled device.

A first illustrative aspect of the presently disclosed subject matter may provide an operation control device, comprising:
a shaft configured to allow a rotation about a rotation axis, the rotation being associated with a first controlled operation;
a grip adapted to be turned about the rotation axis along a turning path, and t be gripped by a hand of a user; and
an input device disposed between the shaft and the grip when viewed from a first direction along the rotation axis,
wherein the input device includes:
   a first operation accepting area associated with a second controlled operation;
   a second operation accepting area disposed between the grip and the fir operation accepting area when viewed from the first direction, and associated with a third controlled operation;
   a first electrode arranged to detect change in electrostatic capacitance caused by approach or contact of a finger of the user with respect to the first operation accepting area; and
   a second electrode arranged to detect change in electrostatic capacitance caused by approach or contact of a finger of the user with respect to the second operation accepting area; and
wherein a length of the first electrode in a second direction along a turning radius of the grip is longer than a length of the second electrode in the second direction.

A second illustrative aspect of the presently disclosed subject matter may provide an input device adapted to be equipped with an operation control device that includes: a shaft configured to allow a rotation about a rotation axis, the rotation being associated with a first controlled operation; and a grip adapted to be turned about the rotation axis along a turning path, and to be gripped by a hand of a user, the input device being adapted to be disposed between the shaft and the grip when viewed from a first direction along the rotation axis, and comprising:
a first operation accepting area associated with a second controlled operation;
a second operation accepting area disposed between the grip and the first operation accepting area when viewed from the first direction, and associated with a third controlled operation;
a first electrode arranged to detect change in electrostatic capacitance caused by approach or contact of a finger of the user with respect to the first operation accepting area; and
a second electrode arranged to detect change in electrostatic capacitance caused by approach or contact of a finger of the user with respect to the second operation accepting area,
wherein a length of the first electrode in a second direction along a turning radius of the grip is longer than a length of the second electrode in the second direction.

When a user attempts to contact the first operation accepting area by extending a finger of the hand holding the grip, a portion near the base of the finger (e.g., a finger pad) may unintentionally contact the second operation accepting area located between the first operation accepting area and the grip. Accordingly, in this case, the operation of the controlled device associated with the second operation accepting area could be executed contrary to the driver's intention to execute the operation of the controlled device associated with the first operation accepting area.

However, according to the configuration of each of the first and second illustrative aspects, of the first electrode and the second electrode arranged side by side in the direction along the turning radius, the dimension in that direction of the one electrode distant from the grip is determined to be longer. Accordingly, the change in the electrostatic capacitance detected by the first electrode in accordance with the approach or contact of the finger tends to be large. As a result, it is possible to suppress occurrence of a situation in which the operation of the controlled device associated with the second operation accepting area is happened to be executed contrary to the driver's intention to execute the operation of the controlled device associated with the first operation accepting area. Accordingly, it is possible to improve the convenience of an operation control device equipped with an input device adapted to control multiple operations of the controlled device.

A third illustrative aspect of the presently disclosed subject matter may provide an operation control device, comprising:
a shaft configured to allow a rotation about a rotation axis, the rotation being associated with a first controlled operation;
a grip adapted to be turned about the rotation axis along a turning path, and t be gripped by a hand of a user; and
an input device disposed between the shaft and the grip when viewed from a direction along the rotation axis,
wherein the input device includes:
   a first operation accepting area associated with a second controlled operation;
   a second operation accepting area disposed between the grip and the fir operation accepting area when viewed from the direction along the rotation axis, and associated with a third controlled operation;
   a first electrode arranged to detect change in electrostatic capacitance caused by approach or contact of a finger of the user with respect to the first operation accepting area;
   a second electrode arranged to detect change in electrostatic capacitance caused by approach or contact of a finger of the user with respect to the second operation accepting area; and
   a guidance protrusion configured such that the finger that has contacted the first operation accepting area can touch; and
   wherein a position of the guidance protrusion is so determined that the finger is forced to have a posture of being separated from the second operation accepting area when a part of the finger touches the guidance protrusion.

A fourth illustrative aspect of the presently disclosed subject matter may provide an input device adapted to be equipped with an operation control device that includes: a shaft configured to allow a rotation about a rotation axis, the rotation being associated with a first controlled operation; and a grip adapted to be turned about the rotation axis along a turning path, and to be gripped by a hand of a user, the input device being adapted to be disposed between the shaft and the grip when viewed from a direction along the rotation axis, and comprising:
a first operation accepting area associated with a second controlled operation;
a second operation accepting area disposed between the grip and the first operation accepting area when viewed from the direction along the rotation axis, and associated with a third controlled operation;
a first electrode arranged to detect change in electrostatic capacitance caused by approach or contact of a finger of the user with respect to the first operation accepting area; and
a second electrode arranged to detect change in electrostatic capacitance caused by approach or contact of a finger of the user with respect to the second operation accepting area; and
a guidance protrusion configured such that the finger that has contacted the first operation accepting area can touch,
wherein a position of the guidance protrusion is so determined that the user's finger is forced to have a posture of being separated from the second operation accepting area when a part of the finger touches the guidance protrusion.

When a user attempts to contact the first operation accepting area by extending a finger of the hand holding the grip, a portion near the base of the finger (e.g., a finger pad) may unintentionally contact the second operation accepting area located between the first operation accepting area and the grip. Accordingly, in this case, the operation of the controlled device associated with the second operation accepting area could be executed contrary to the driver's intention to execute the operation of the controlled device associated with the first operation accepting area.

However, according to the configuration of each of the third and fourth illustrative aspects, since the finger is naturally separated from the second operation accepting area when the part of the finger touches the guidance protrusion, it is possible to suppress occurrence of a situation in which the operation of the controlled device associated with the second operation accepting area is happened to be executed contrary to the driver's intention to execute the operation of the controlled device associated with the first operation accepting area. In addition, it is unnecessary to force the driver to take particular care for avoiding the second operation accepting area. Accordingly, it is possible to improve the convenience of an operation control device equipped with an input device adapted to control multiple operations of the controlled device.

### DESCRIPTION OF THE DRAWINGS

FIG. 1 illustrates a steering device according to an exemplary embodiment.

FIG. 2 illustrates an appearance of an input device adapted to be equipped with the steering device of FIG. 1.

FIG. 3 illustrates a cross-section along the line III-III in FIG. 2 when viewed from an arrowed direction.

FIG. 4 is a drawing for explaining operations of a comparative exemplary input device.

FIG. 5 is a drawing for explaining operations of the input device of FIG. 4.

FIG. 6 is a drawing for explaining operations of the input device of FIG. 2.

FIG. 7 is a drawing for explaining operations of the input device of FIG. 2.

FIG. 8 is a drawing for explaining operations of an input device having another exemplary configuration.

FIG. 9 is a drawing for explaining operations of the input device of FIG. 8.

### DESCRIPTION OF EMBODIMENTS

Exemplary embodiments will be described in detail below with reference to the accompanying drawings. In the drawings used in the following descriptions, the scale thereof is changed as required in order to make each element to a recognizable size.

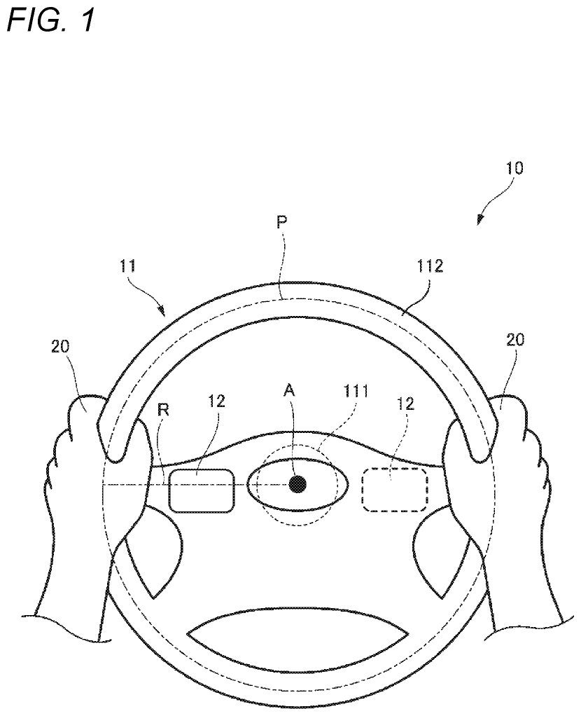

FIG. 1 illustrates an appearance of a steering device 10 according to an exemplary embodiment. The steering device 10 is a device adapted to be disposed in a cabin of a vehicle to cause the vehicle to perform an operation of changing a traveling direction. The steering device 10 is an exemplary operation control device. The operation of changing the traveling direction is an exemplary first controlled operation. The vehicle is an exemplary mobility.

The steering device 10 includes a steering member 11. The steering member 11 includes a shaft 111 and a grip 112. The shaft 111 is adapted to be rotated about a rotation axis A. The grip 112 is adapted to be gripped by a driver's hand 20. The driver is an exemplary user. The grip 112 is adapted to be turned along a turning path P about the rotation axis A. As the grip 112 is turned by the driver's hand 20, the shaft 111 turns in the same direction. The turning direction is associated with the traveling direction of the vehicle to be changed.

The steering device 10 includes an input device 12. The input device 12 is disposed between the shaft 111 and the grip 112 when viewed from a direction along the rotation axis A.

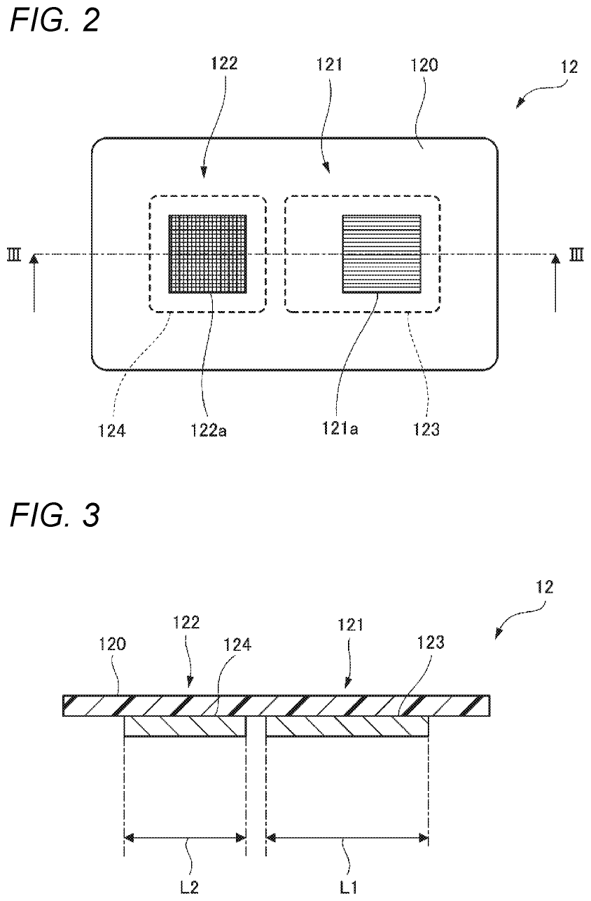

FIG. 2 illustrates an appearance of the input device 12 when viewed from the direction along the rotation axis A. The input device 12 includes an operation accepting face 120. The operation accepting face 120 is disposed at a position where a finger of a driver's hand holding the grip 112 of the steering member 11 can reach.

The operation accepting face 120 includes a first operation accepting area 121 and a second operation accepting area 122. The first operation accepting area 121 is associated with an operation of a controlled device installed in the vehicle. The second operation accepting area 122 is associated with another operation of the controlled device installed in the vehicle.

Examples of the controlled device include a device for adjusting a position of equipment installed in a vehicle (a seat, a steering device, a window, a rearview mirror, and the like), a lighting device, an air conditioner, and an audio-visual device. The operation associated with the first operation accepting area 121 and the operation associated with the second operation accepting area 122 may be different operations of an identical controlled device, or operations of different controlled devices. The operation associated with the first operation accepting area 121 is an exemplary second controlled operation. The operation associated with the second operation accepting area 122 is an exemplary third controlled operation.

The first operation accepting area 121 and the second operation accepting area 122 are arranged to be side by side along a turning radius R of the grip 112 of the steering member 11 illustrated in FIG. 1 when viewed from the direction along the rotation axis A. The second operation accepting area 122 is disposed between the first operation accepting area 121 and the grip 112 when viewed from the direction along the rotation axis A.

In this example, each of the first operation accepting area 121 and the second operation accepting area 122 is provided with no physical boundary structure with respect to other areas in the operation accepting face 120. In other words, each of the first operation accepting area 121 and the second operation accepting area 122 is flush with the operation accepting face 120.

In the first operation accepting area 121, an icon 121a is provided so that the driver can recognize the associated operation of the controlled device. The icon 121a is configured with at least one of characters, numerals, symbols, graphics, pictures, and colors.

Similarly, an icon 122a is provided in the second operation accepting area 122 so that the driver can recognize the associated operation of the controlled device. The icon 122a is configured to be distinguishable from the icon 121a using at least one of characters, numerals, symbols, graphics, pictures, and colors.

FIG. 3 illustrates a cross-section along the line III-III in FIG. 2 when viewed from an arrowed direction. The input device 12 includes a first electrode 123 and a second electrode 124.

The first electrode 123 is disposed behind the operation accepting face 120. The first electrode 123 is provided for detecting change in electrostatic capacitance caused by approach or contact of a driver's finger with respect to the first operation accepting area 121.

The second electrode 124 is disposed behind the operation accepting face 120 as well. The second electrode 124 is provided for detecting change in electrostatic capacitance caused by approach or contact of a driver's finger with respect to the second operation accepting area 122.

Accordingly, the first electrode 123 and the second electrode 124 are arranged side by side along the turning radius R of the grip 112 of the steering member 11 illustrated in FIG. 1 when viewed from the direction along the rotation axis A. The second electrode 124 is disposed between the first electrode 123 and the grip 112 when viewed from the direction along the rotation axis A.

The input device 12 includes a processing device (not illustrated). The processing device is implemented by a computing element such as a microcontroller.

As change in the electrostatic capacitance caused by the approach or contact of the driver's finger to the first operation accepting area 121 is detected by the first electrode 123, the processing device outputs a signal for executing the operation of the controlled device associated with the first operation accepting area 121. As long as the signal indicates the approach or contact of the finger to the first operation accepting area 121, the signal may not be adapted to directly cause the controlled device to perform an operation as associated.

As change in the electrostatic capacitance caused by the approach or contact of the driver's finger to the second operation accepting area 122 is detected by the second electrode 124, the processing device outputs a signal for executing the operation of the controlled device associated with the second operation accepting area 122. As long as the signal indicates the approach or contact of the finger to the second operation accepting area 122, the signal may not be adapted to directly cause the controlled device to perform an operation as associated.

In a case where a driver's finger approaches or contacts both the first operation accepting area 121 and the second operation accepting area 122, change in the electrostatic capacitance is simultaneously detected in each of the first electrode 123 and the second electrode 124. In this case, the processing device outputs a signal for executing an operation of the controlled device associated with the operation accepting area in which a larger change in the detected electrostatic capacitance is detected.

In the present exemplary embodiment, a length L1 of the first electrode 123 in the direction along the turning radius R of the grip 112 of the steering member 11 is longer than a length L2 of the second electrode 124 in the same direction. In other words, of the first electrode 123 and the second electrode 124 arranged side by side in the direction along the turning radius R, a dimension in that direction of the one electrode distant from the grip 112 is determined to be longer.

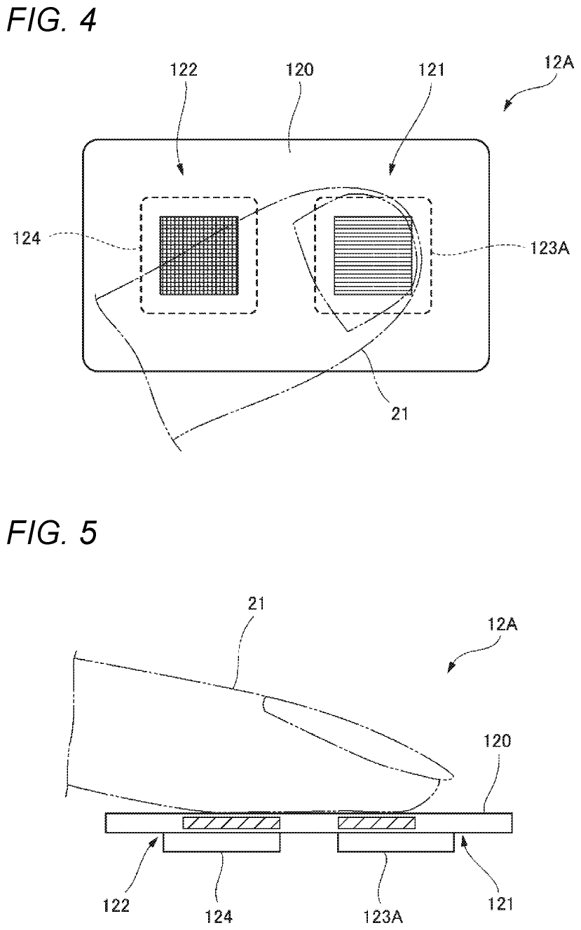

FIGS. 4 and 5 illustrate an input device 12A according to a comparative example. Components substantially the same as those of the input device 12 according to the present exemplary embodiment are assigned with the same reference numerals, and repetitive descriptions for those will be omitted. The input device 12 includes a first electrode 123A. A dimension of the first electrode 123A in the direction along the turning radius R of the grip 112 of the steering member 11 is the same as a dimension of the second electrode 124 in the same direction.

FIGS. 4 and 5 illustrate a state in which a driver's finger contacts both the first operation accepting area 121 and the second operation accepting area 122. When a driver attempts to contact the first operation accepting area 121 by extending a finger 21 of the hand 20 holding the grip 112, a portion near the base of the finger 21 (e.g., a finger pad) may unintentionally contact the second operation accepting area 122 located between the first operation accepting area 121 and the grip 112. In this case, as described above, change in the electrostatic capacitance is detected in each of the first electrode 123A and the second electrode 124.

The hatched portions in FIG. 5 represent portions where parts of the finger 21 contact the first operation accepting area 121 and the second operation accepting area 122. In this example, the change in the electrostatic capacitance detected by the second electrode 124 caused by the contact with the second operation accepting area 122 is larger than the change in the electrostatic capacitance detected by the first electrode 123 caused by the contact with the first operation accepting area 121. Accordingly, in this case, the operation of the controlled device associated with the second operation accepting area 122 is happened to be executed contrary to the driver's intention to execute the operation of the controlled device associated with the first operation accepting area 121.

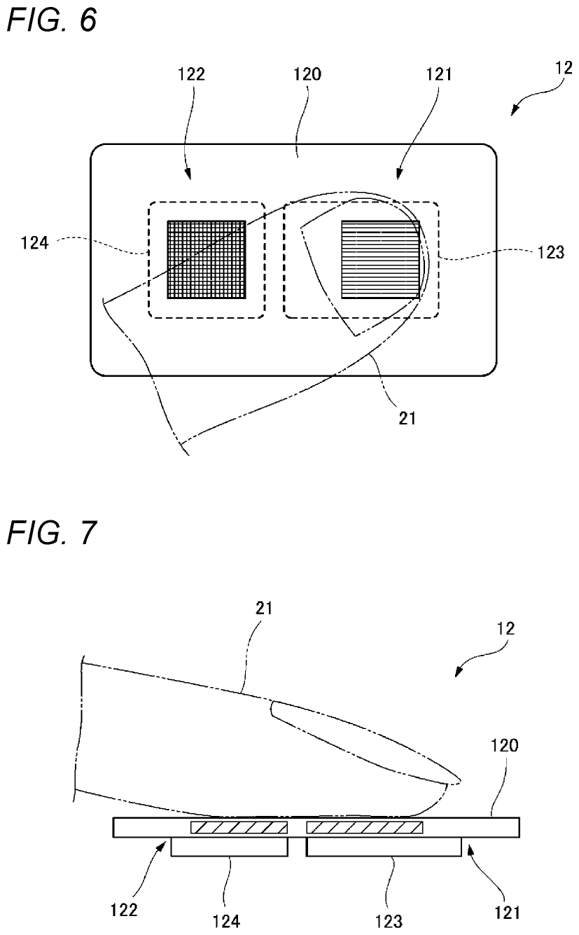

FIGS. 6 and 7 illustrate a state in which the driver's finger contacts both the first operation accepting area 121 and the second operation accepting area 122 of the input device 12 according to the present exemplary embodiment. The contact state of the finger 21 is the same as that illustrated in FIGS. 4 and 5.

However, according to the configuration of the present exemplary embodiment, of the first electrode 123 and the second electrode 124 arranged side by side in the direction along the turning radius R, the dimension in that direction of the one electrode distant from the grip 112 is determined to be longer. Accordingly, the change in the electrostatic capacitance detected by the first electrode 123 in accordance with the approach or contact of the finger 21 tends to be large. As a result, it is possible to suppress occurrence of a situation in which the operation of the controlled device associated with the second operation accepting area 122 is happened to be executed contrary to the driver's intention to execute the operation of the controlled device associated with the first operation accepting area 121.

In addition, since the first electrode 123 and the second electrode 124 are invisible behind the first operation accepting area 121 and the second operation accepting area 122, it is unnecessary to require change in the appearance with respect to the first operation accepting area 121 and the second operation accepting area 122, or particular care as for how to perform an operation with the driver's finger 21 in order to obtain the above advantage.

Accordingly, it is possible to improve the convenience of the steering device 10 equipped with the input device 12 adapted to control multiple operations of the controlled device.

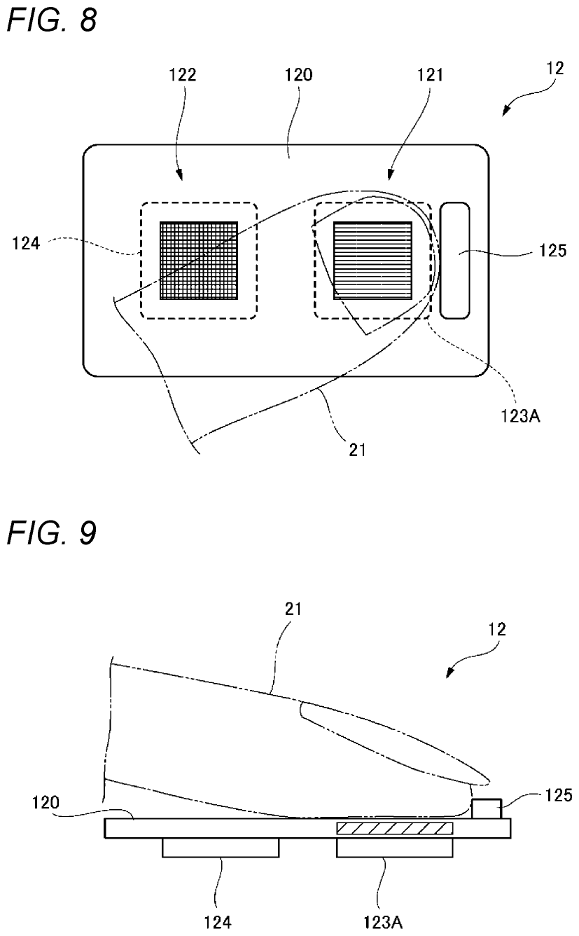

As illustrated in FIGS. 8 and 9, the input device 12 may include a guidance protrusion 125. The guidance protrusion 125 is so configured that the driver's finger 21 that has contacted the first operation accepting area 121 can touch. In this example, the guidance protrusion 125 is disposed between the shaft 111 and the first operation accepting area 121 when viewed from the direction along the rotation axis A of the steering member 11. More specifically, the position of the guidance protrusion 125 is determined such that the finger 21 is forced to have a posture of being separated from the second operation accepting area 122 when a part of the finger 21 such as a fingertip touches the guidance protrusion 125.

According to such a configuration, by touching the guidance protrusion 125 with a part of the finger 21 of the driver who wishes to perform the operation of the controlled device associated with the first operation accepting area 121, it is possible to suppress occurrence of a situation in which another part of the finger 21 happens to contact the second operation accepting area 122 at the same time. As a result, it is possible to suppress occurrence of a situation in which the operation of the controlled device associated with the second operation accepting area 122 is happened to be executed contrary to the driver's intention to execute the operation of the controlled device associated with the first operation accepting area 121.

In addition, since the finger 21 is naturally separated from the second operation accepting area 122 when the part of the finger 21 touches the guidance protrusion 125, it is unnecessary to force the driver to take particular care for avoiding the second operation accepting area 122 when performing the operation of contacting the finger 21 with the first operation accepting area 121.

Accordingly, it is possible to improve the convenience of the steering device 10 equipped with the input device 12 adapted to control multiple operations of the controlled device.

In this example, the first electrode 123A according to the comparative example described with reference to FIGS. 4 and 5 is associated with the first operation accepting area 121. In other words, the restriction related to the length of the first electrode 123 in the direction along the turning radius R of the grip 112 described with reference to FIGS. 2 and 3 can be ignored.

However, the guidance protrusion 125 may be provided with the configuration having the first electrode 123 described with reference to FIGS. 2 and 3. In this case, it is possible to more reliably suppress occurrence of the situation in which the operation of the controlled device associated with the second operation accepting area 122 is happened to be executed contrary to the driver's intention to execute the operation of the controlled device associated with the first operation accepting area 121.

The foregoing description of various configurations is provided merely by way of illustration to facilitate understanding of the presently disclosed subject matter. Each of the above exemplary configurations may be appropriately modified or combined with another exemplary configuration within the scope of the presently disclosed subject matter.

In the above exemplary embodiment, the input device 12 is disposed at a position capable of being operated with a finger of a left hand of the driver. Additionally or alternatively, as illustrated in FIG. 1, the input device 12 may be disposed at a position capable of being operated with a finger of a right hand of the driver. In this case, the first operation accepting area 121 is disposed in a position in the left of the second operation accepting area 122.

The shape of the steering member 11 need not be annular. As long as the turning radius R about the rotation axis A and the turning path P of the grip 112 can be defined, the shape of the steering member 11 may be arbitrary. The grip 112 may have a shape in which a portion gripped by a left hand of the driver and a portion gripped by a right hand of the driver are independent from each other.

The input device 12 may be equipped with a steering device for changing the traveling direction of a mobility other than the vehicle. Examples of another mobility include a railway, a ship, and an aircraft. The function other than the direction indicating function and the controlled operation associated with the function may be appropriately determined according to the specification of the mobility.

The input device 12 need not be installed in a steering device of a mobility. For example, a controller equipped with the shaft 111 and the grip 112 can be used to control movements of an object to be displayed on a display of a simulator device for training control of a mobility, or a display of a game device in an amusement facility. The first operation accepting area 121 and the second operation accepting area 122 can be used by a user to select one of multiple functions adapted to be executed by the object, and to execute an operation associated with the selected function. In this case, the controller is an exemplary operation control device. The movement of the object is an exemplary first controlled operation. The operation associated with each function adapted to be executed by the object is an exemplary second controlled operation.

1. An operation control device, comprising:
a shaft configured to allow a rotation about a rotation axis, the rotation being associated with a first controlled operation;
a grip adapted to be turned about the rotation axis along a turning path, and t be gripped by a hand of a user; and
an input device disposed between the shaft and the grip when viewed from a first direction along the rotation axis,
wherein the input device includes:
a first operation accepting area associated with a second controlled operation;
a second operation accepting area disposed between the grip and the fir operation accepting area when viewed from the first direction, and associated with a third controlled operation;
a first electrode arranged to detect change in electrostatic capacitance caused by approach or contact of a finger of the user with respect to the first operation accepting area; and
a second electrode arranged to detect change in electrostatic capacitance caused by approach or contact of a finger of the user with respect to the second operation accepting area; and
wherein a length of the first electrode in a second direction along a turning radius of the grip is longer than a length of the second electrode in the second direction.

2. The operation control device according to claim 1,
wherein the input device includes a guidance protrusion configured such that the finger that has contacted the first operation accepting area can touch; and
wherein a position of the guidance protrusion is so determined that the finger is forced to have a posture of being separated from the second operation accepting area when a part of the finger touches the guidance protrusion.

3. An operation control device, comprising:
a shaft configured to allow a rotation about a rotation axis, the rotation being associated with a first controlled operation;
a grip adapted to be turned about the rotation axis along a turning path, and t be gripped by a hand of a user; and
an input device disposed between the shaft and the grip when viewed from a direction along the rotation axis,
wherein the input device includes:
a first operation accepting area associated with a second controlled operation;
a second operation accepting area disposed between the grip and the fir operation accepting area when viewed from the direction along the rotation axis, and associated with a third controlled operation;
a first electrode arranged to detect change in electrostatic capacitance caused by approach or contact of a finger of the user with respect to the first operation accepting area;
a second electrode arranged to detect change in electrostatic capacitance caused by approach or contact of a finger of the user with respect to the second operation accepting area; and
a guidance protrusion configured such that the finger that has contacted the first operation accepting area can touch; and
wherein a position of the guidance protrusion is so determined that the finger is forced to have a posture of being separated from the second operation accepting area when a part of the finger touches the guidance protrusion.

4. The operation control device according to claim 1,
wherein the first controlled operation is changing a travel direction of a mobility; and
wherein the second controlled operation and the third controlled operation are different operations of at least one controlled device installed in the mobility.

5. The operation control device according to claim 3,
wherein the first controlled operation is changing a travel direction of a mobility; and
wherein the second controlled operation and the third controlled operation are different operations of at least one controlled device installed in the mobility.

6. An input device adapted to be equipped with an operation control device that includes: a shaft configured to allow a rotation about a rotation axis, the rotation being associated with a first controlled operation; and a grip adapted to be turned about the rotation axis along a turning path, and to be gripped by a hand of a user, the input device being adapted to be disposed between the shaft and the grip when viewed from a first direction along the rotation axis, and comprising:
a first operation accepting area associated with a second controlled operation;
a second operation accepting area disposed between the grip and the first operation accepting area when viewed from the first direction, and associated with a third controlled operation;
a first electrode arranged to detect change in electrostatic capacitance caused by approach or contact of a finger of the user with respect to the first operation accepting area; and
a second electrode arranged to detect change in electrostatic capacitance caused by approach or contact of a finger of the user with respect to the second operation accepting area,
wherein a length of the first electrode in a second direction along a turning radius of the grip is longer than a length of the second electrode in the second direction.

7. An input device adapted to be equipped with an operation control device that includes: a shaft configured to allow a rotation about a rotation axis, the rotation being associated with a first controlled operation; and a grip adapted to be turned about the rotation axis along a turning path, and to be gripped by a hand of a user, the input device being adapted to be disposed between the shaft and the grip when viewed from a direction along the rotation axis, and comprising:
a first operation accepting area associated with a second controlled operation;
a second operation accepting area disposed between the grip and the first operation accepting area when viewed from the direction along the rotation axis, and associated with a third controlled operation;
a first electrode arranged to detect change in electrostatic capacitance caused by approach or contact of a finger of the user with respect to the first operation accepting area; and
a second electrode arranged to detect change in electrostatic capacitance caused by approach or contact of a finger of the user with respect to the second operation accepting area; and
a guidance protrusion configured such that the finger that has contacted the first operation accepting area can touch,
wherein a position of the guidance protrusion is so determined that the user's finger is forced to have a posture of being separated from the second operation accepting area when a part of the finger touches the guidance protrusion.
